(19) United States
(12) Patent Application Publication
(10) Pub. No.: US 2014/0289530 A1
(43) Pub. Date: Sep. 25, 2014

(54) SYSTEMS AND METHODS FOR CONTENT DELIVERY

(71) Applicant: NetApp, Inc., Sunnyvale, CA (US)

(72) Inventors: Abraham Benjamin De Waal, San Jose, CA (US); Gary King, Los Altos, CA (US); Michael Rothrock, San Francisco, CA (US); Nick Triantos, Woodside, CA (US)

(73) Assignee: NetApp, Inc., Sunnyvale, CA (US)

(21) Appl. No.: 14/354,103

(22) PCT Filed: Oct. 24, 2012
(86) PCT No.: PCT/US2012/061721

§ 371 Date: Apr. 24, 2014

Related U.S. Application Data
(60) Provisional application No. 61/550,790, filed on Oct. 24, 2011.

(51) Int. Cl. H04L 29/08; H04L 29/06

(52) U.S. Cl. CPC H04L 67/10; H04L 63/08; H04L 63/0435
USPC 713/171; 709/204; 726/4

(57) ABSTRACT

A system, computer-readable storage medium storing at least one program, and computer-implemented method for content delivery is provided. A content sharing session is established between a user device and a content system. Content primitives are generated from a content item controlled by the content system. Each of the generated content primitives is accessed and transmitted to the user device.

### CROSS-REFERENCE TO RELATED APPLICATIONS

This application claims the benefit of the filing date of U.S. application Ser. No. 61/550,790, filed on Oct. 24, 2011, the disclosure of which is incorporated by reference herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2011, 2012, ionGrid, Inc. All Rights Reserved.

### TECHNICAL FIELD

This patent document pertains generally to the networked communications and more particularly, but not by way of limitation, to systems and methods for content delivery and presentation.

### BACKGROUND

The increasingly widespread adoption of technology to support collaborative work on the authoring and review of content (e.g., documents, presentations etc.) has presented to a number of technical challenges, ranging from security challenges to resolving conflicts between competing edits to content from multiple authors.

### BRIEF DESCRIPTION OF THE DRAWINGS

Some embodiments are illustrated by way of example and not limitation in the accompanying figures in which:

FIG. 1 is a diagram of an example environment in which embodiments may operate.

FIG. 2 is a flowchart depicting an example method of establishing a content session between a user device, a session management system, and a content management system according to an embodiment.

FIG. 3 is a flowchart depicting an example method of establishing a content session between a user device, a local content system, and a federated partner's content system according to an embodiment.

FIG. 4 is a flowchart depicting example content system streaming operations in accordance with an embodiment.

FIG. 5 is a flowchart depicting example content preparation operations of a content system in accordance with an embodiment.

FIG. 6 is a diagram of a map of a discretized content item in accordance with an embodiment.

FIG. 7 is a flowchart depicting example operations performed by a user device in accordance with an embodiment.

FIG. 8 is a depiction of a portion of a user interface provided by a user device in accordance with an embodiment.

FIG. 9 is a flowchart depicting an example access delegation method performed by a session management system and content management system in accordance with an embodiment.

FIG. 10 is a flowchart depicting an example method of authenticating a guest user of a content system.

FIG. 11 is a block diagram of a machine configurable to implement various embodiments of the invention.

### DETAILED DESCRIPTION

In the following description, for purposes of explanation, numerous specific details are set forth in order to provide a thorough understanding of some example embodiments. It will be evident, however, to one skilled in the art that the present inventions may be practiced without these specific details.

The systems and methods described allow a user device connected to a public network to access and stream content stored by a content system residing on or controlled by a private network. A content sharing session is established between the user device and the content system with a session management system acting as an intermediary in the communication. The content system resides on a secure private network, while the session management system resides on public network. The session management system performs policy checks and authenticates a user device prior to any communication with the private content system. Once a user is authenticated by the session management system, the content system also performs policy checks and user authentication before a content sharing session is finally established and content is streamed to the user device. The user of the user device is then able to access content residing on or controlled by a content system without a copy of the content residing on the user device itself.

Other embodiments allow a user of a user device to delegate access to one or more content items to another guest user device. Another embodiment allows a user device to connect to a partner content system located on another private network through a content system located on a private network which the user device is also connected.

### System Overview

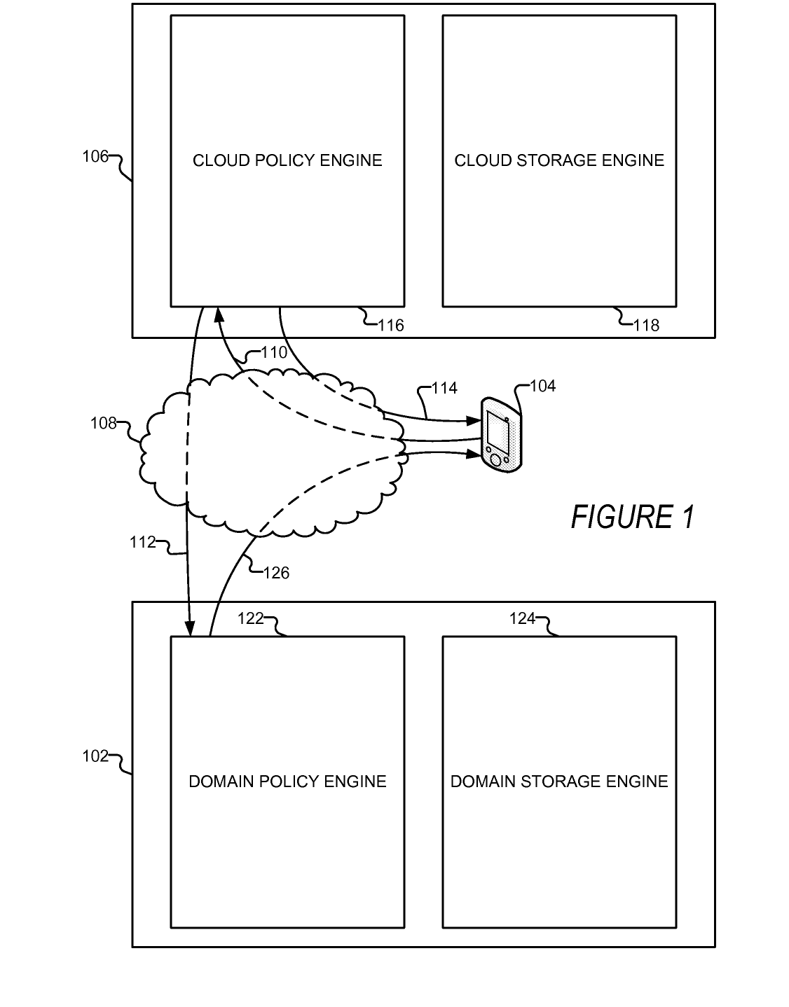

FIG. 1 is a block diagram illustrating a content sharing environment 100, according to one example embodiment. This embodiment may allow content to be stored at a content system 102 and accessed by remote user devices 104 (i.e. devices that are not part of the secure network environment of the content system). Content access may be achieved by establishing a content session between the content system 102 and the user device 104 in question. During the content session, content (or content items) may be streamed from the content system 102 to the user device 104 via the cloud session management system 106. Establishment of the content session during which the content is streamed is facilitated by a cloud session management system 106. The content system 102, the user device 104, and the cloud session management system 106 are interconnected by a network 108 (for example, the Internet).

In an example embodiment, and again by way of high level overview, to establish a content session between the user device 104 and the content system 102, the user device 104 sends an initial content request 110 to the session management system 106. The initial content request includes details of both the content item for which access is sought, and the credentials supporting that request (e.g. details such as a user identifier, password, token, or key of the user device 104 and/or the user of the user device 104). The cloud session management server 106 receives the initial content request 110, determines the content system 102 from a plurality of content systems 102 at which the requested content item is stored, authenticates the request (by reference to request credentials and permission information associated with the content system 102), and, providing authentication is successful, sends an authenticated content request 112 to the content system 102. The authenticated content request 112 includes details of the content item requested and the user/user device 102 making the request.

Once the content system 102 receives the content request 112 from the cloud session management server 106, the content system 102 then perform further policy checks to successfully authenticate the content request 112. After the content request 112 has been successfully completed by the content system 102, a content session is established and the user device 104 is able to access the content. In the example embodiment, the content session connection 114 is established between the user device 104 and the cloud session management system 106.

In another embodiment, the content session connection 126 is made directly between the user device 104 and the content system 102. In this embodiment, there is no necessity for further policy checks to authenticate the user device 104. For example, once a user and a user device have been authenticated to receive a particular content item, the content item itself may be delivered directly to the user device.

### The Content System

In an example embodiment, the content system 102 comprises a domain policy engine 122. The domain policy engine 122 enforces the policies of the content system. These policies include, for example, access controls, allowed users, and authentication mechanisms. The domain policy engine 122 relies on a domain storage engine 124 to aggregate and access the appropriate databases to obtain polices, user authorizations, and user roles and permissions.

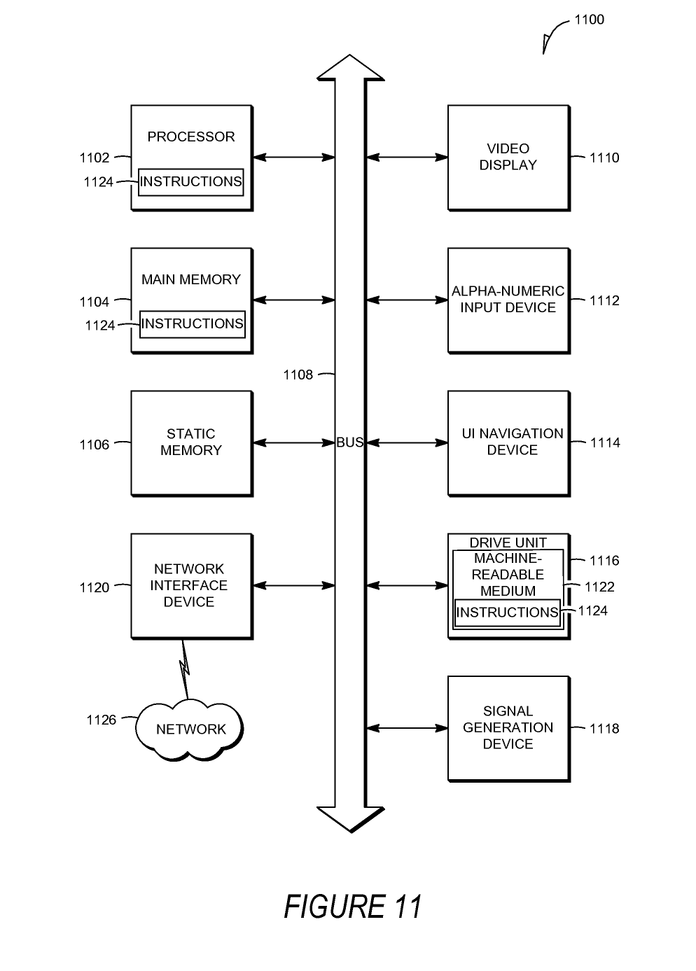

The content system 102 includes at least one domain storage engine 124 in communication with one or more databases. In this instance, the domain storage engine 124 may be in communication various different databases. For instance, domain storage engine 124 may be connected to a network accessible content database for content, a SharePoint database for content and/or user accounts and access controls, an SQL database for content and/or user accounts and access controls and/or a directory database such as Active Directory. The domain storage engine 124 may be a stand-alone machine similar to that depicted in FIG. 11 and described in detail below, or may be a storage engine module running on such a machine. Typically the content system 102 will be a private system, with its various components secured against other machines having access to the network 108 by appropriate hardware and/or software network security measures.

To facilitate the serving of content to a remote user device 104, the domain storage engine 124 includes one or more content server modules. Each content server module provides various server parameters to be configured, user accounts and permissions to be created and administered, content items to be designated as being available to one or more users or user groups, content to be processed for streaming, and the ability to establish content sessions with remote user devices for streaming content.

### Session Management System

The session management system 106 includes a cloud policy engine 116 and a cloud storage engine 118, which may be a dedicated server (e.g. a machine similar to that depicted in FIG. 11 and described in detail below), or a server module running on such a machine. Session management system 106 may access one or more databases or other resources in order to perform its required functions.

The session management system 106 is publicly accessible over the network 108 and facilitates the establishment of content sessions between content systems and user devices which are configured to support such sessions (e.g. content system 102 and user device 104).

To this end, the session management system 106 includes at least one cloud policy engine 116 modules which provide for the management of content system information (i.e. information in respect of content systems such as system 102 which have been configured to stream content to remote devices such as 104), receive requests to establish content sessions between content systems and remote devices, authenticate remote devices for content access, and communicate authenticated content requests to the relevant content system.

### the User Device

In the example of FIG. 1, the user device 104 is depicted as a tablet computing device such as an iPad. Alternative user computing devices are, of course, possible. By way of non-limiting example suitable user devices may include mobile telephones, smart phones, laptop computers, netbook computers, desktop computers, gaming systems, and set top boxes.

More generally speaking, the user device 104 may include some or all of the components of the machine depicted in FIG. 11 and described in detail below.

User device 104 includes or more user device modules (not depicted) by which a user of the user device 104 can interact with the content system 102 and session management system 106. For example, the user device 104 includes an encryption module, a cache module, a transport module, and a user interface module, though relevant functions may be implemented via additional or alternative modules. These modules variously allow a user using the user device 104 to browse or search for content items from the content system 102 that are accessible, and allow the user device 104 to request content items from the content system 102, establish a content session with the content system 102, receive content items (e.g., primitives that form part of the content items), and present the content items to the user.

### Establishing a Session

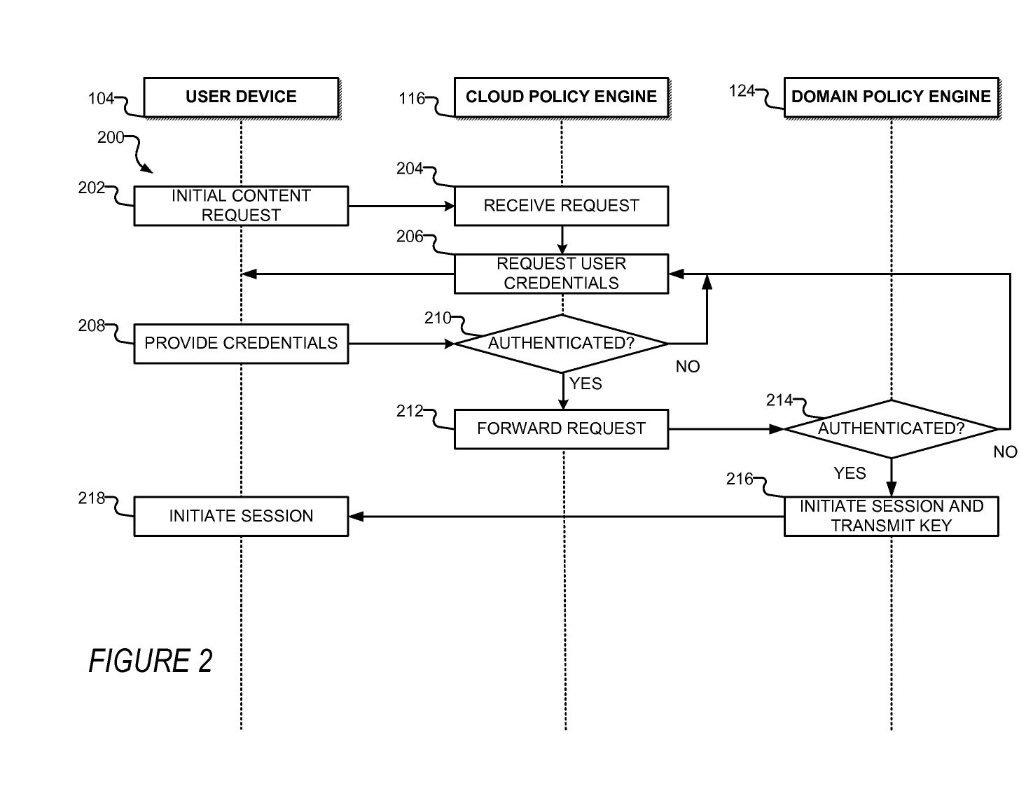

FIG. 2 is flowchart that depicts an example method of establishing a content session connection between a user device 104 and the content system 102 in accordance with an example embodiment. As used herein, the term “block” when used to refer to a reference number in the figures, is used to indicate an operation or method step being performed.

At block 202, an initial content request 110 is received from a user device 104 by the content system 102. The initial content request 110 may designate one or more content items that are accessible by one or more users. The requested content item may be locally accessible from the content system 102 (e.g., from an electronic storage device such as a hard drive, flash drive, CD, DVD, etc) or remotely accessible from the content system 102 (e.g., from a network attached storage application or device).

Content items may be stored in one or more shared content directories. Content items may be added to a shared content directory on an individual content item (e.g., file) basis, on a directory basis (e.g., selecting a directory such that all files in the directory are designated to be shared content items), or by a search type function (e.g., a function to add all .pdf files in one or more directories, or on one or more drives, to a shared content directory). In some embodiments, the shared content directory or directories are indexed to allow for efficient searching of the shared content items.

The initial content request 110 may include an identifier of the desired content item together with user credentials. The user credentials may include information in respect of the user device 104 itself (e.g. a MAC address of the device, a serial number of the device), contextual information (e.g. the physical location of the device as provided by a GPS unit or other means), and/or information regarding the user (e.g. a login name, password, biometric, and/or other user information).

At block 204, the initial request for content 110 made by the user is received by the session management system 106. At block 206, cloud policy engine 116 prompts the user of the user device 104 to input a username. In another embodiment, the session management system 106 will require a user to enter a username and other access credentials. For example, the session management system 106 may require a user to input the location of the content being requested. In another embodiment, the session management system 106 will recognize that a session has already been established with the particular user and will instead access stored credential information.

At block 210, the cloud policy engine 116 checks the local access controls to insure that the user name and credential information provided by the user are sufficient and correct. If the username and credentials initially supplied by the user of the user device 104 are found to be incorrect or insufficient, the cloud policy engine 116 prompts the user of the user device 104 to either re-input a username and credentials or input additional credentials. For example, if the system requires multifactor authentication, the user will be re-prompted at block 208 to input additional credentials to satisfy the requirements of the system. Another example is, in the event a user supplies an incorrect username or other incorrect credentials that are not recognized by the session management system 106, the user would once again be prompted to input a username and credentials.

After the cloud policy engine 116 has confirmed that the user name and credentials are sufficient, the cloud policy engine 116 will forward the request for content to the content management system 102 at block 212. In one embodiment, the content request 112 will include the user name, credentials, and the location information for the content for which access is sought.

Upon receipt of the authenticated content request 112 from cloud policy engine 116, the domain policy engine 122 will access the local access controls at block 214 to verify the sufficiency of the user name and credentials. If the username or credentials are found to be incorrect or insufficient, the user will be prompted to once again enter this information at block 216.

Once the content management system verifies the sufficiency of the username and credentials, the cloud policy engine 116 authenticates the user of user device 104 and a session is established at block 216. Upon establishing a session, the domain policy engine 122 transmits a key to the user device 104. After receiving the key from the domain policy engine 122, the user of the user device 104 initiates the session at block 220.

### Accessing Content

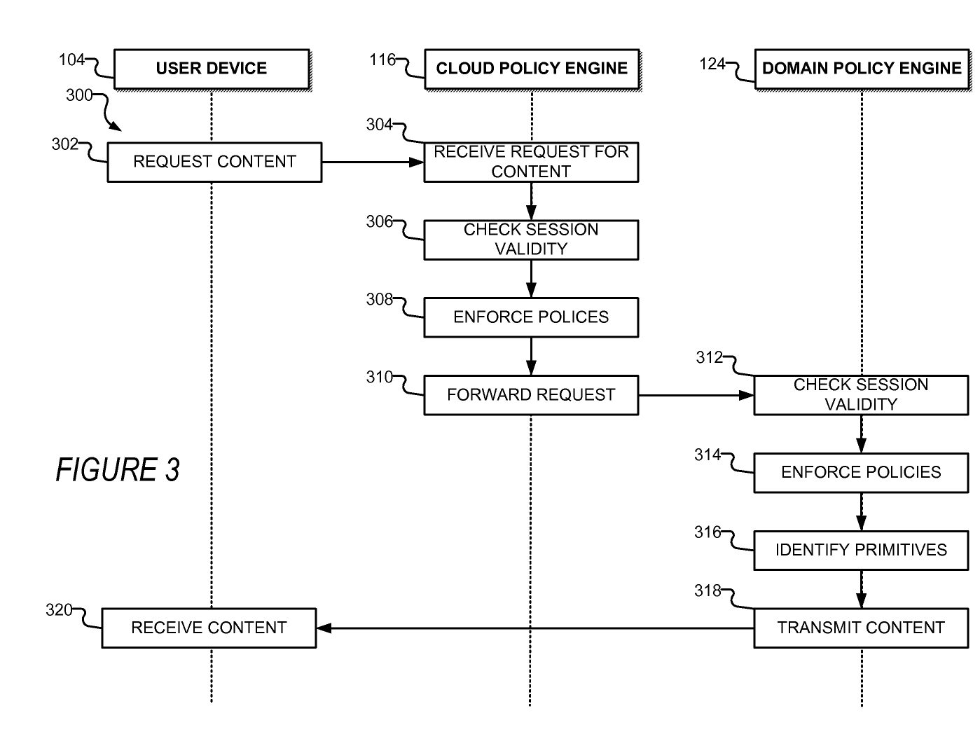

After a user of a user device 104 establishes a content session with the content management system 106, the user device 104 is able to access content located on one of the domain servers (e.g., content management system 102). FIG. 3 is a flow chart of an example method 300 of a user of user device 104 accessing content on the content management system 102. At block 302, the user may request access to particular content (e.g., a file like a particular document) or derived content (e.g., a portion of a file like a single page or paragraph of the document). In another example, the user may request access to an entire slideshow, or the user may request access to a single slide of a particular slideshow. As a further example, a user may request a bitmap image or thumbnail rendering of a page or slide.

At block 304, the cloud policy engine 116 receives the request for a particular content item from the user device 104. At block 306, the cloud policy engine 116 checks the validity of the session. At block 308, the cloud policy engine 116 checks the local access permissions associated with the content item for which access is requested. Permissions may be set on a user-by-user basis, and/or on a group basis. Permissions may, for example, designate a time period in which a user or user group can access the content item; a total number of times a user or user group can access the content item; whether a user or user group can cache or save the content item to their user device; whether a user or user group can edit or suggest edits to a content item; and whether the user or user group can give permission to other users to access the content item.

Information regarding users or user groups authorized to access a content item and the permissions with respect to a given user or user group's access to the content item (set at block 206) are, in this particular embodiment, stored on policy database connected to the cloud storage engine 118.

Upon verification that the local access permissions allow the user to access the content for which access is requested, the cloud policy engine 116 forwards the request for a particular content to the domain policy engine 122 at block 310.

At block 312, domain policy engine 124 receives the request to access particular content and checks to see if the session is valid. Once the domain policy engine 124 determines that the session is valid, the domain policy engine 124 will enforce all policies defined by the local access permissions at block 314. After the domain policy engine 122 enforces the local expressed permissions and determines that the user has permission to access the particular content, the domain policy engine 122 will identify primitives for the requested content. Details of the process by which content primitives are identified and created are discussed below.

At block 318, domain policy engine 122 transmits the requested content to the user device 104. At block 320, the user of the user device 104 receives the content and is able to interact with the content as desired. Details of the process by which content is streamed to the user are discussed below.

### Establishing a Connection to a Federated Partner

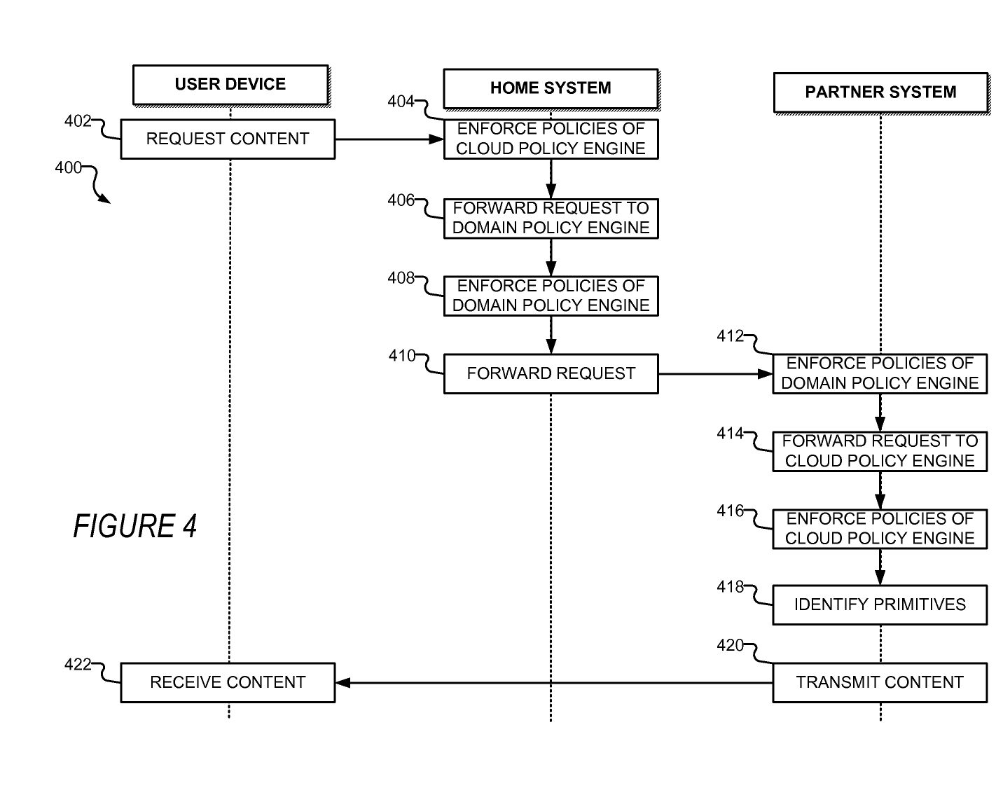

In another embodiment, a user of user device 104 belonging to a first organization, the home system, may access content from a second organization, the partner system, if the second organization is a federated partner of the first organization. Both the home system and the partner system each have separate implementations of the system described in FIG. 1. In this embodiment, a user device 104 connects and obtains a session with the content system 102 of the first organization in the same manner as described by operation 200. FIG. 4 is a flowchart of an example method 400 of a user establishing a content session with a federated partner.

At block 402, the user device 104 may send a request to the cloud policy engine 116 of the home system for content located on a partner system. The home cloud policy engine 116 enforces the policies and permissions of the home system at block 404 and forwards the request to the home cloud policy engine 116 at block 406.

At block 408, the home domain policy engine 122 will enforce the permissions and policies of the home domain system. The home domain policy engine 122 will then forward the request to the partner cloud policy engine 116 at block 410. The partner cloud policy engine 116 receives the request and enforces the policies of the session management system 106 at block 412. The partner cloud policy engine 116 then forwards the request to the partner cloud policy engine 116 at block 414. At block 416, the session management system 106 will enforce the policies and permissions of the session management system 106. The session management system 106 enforces the policies of the system and identifies the primitives of the content at block 418. Details of the process by which content primitives are identified and created are discussed below.

At block 420, the requested content is sent back to the user which is received at the user device 104.

### Content Preparation and Streaming

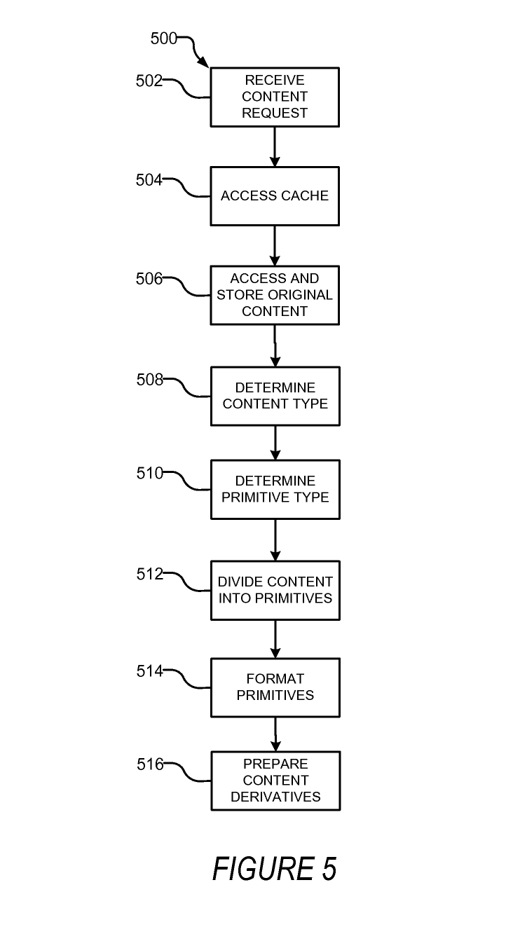

Prior to user device 104 receiving access to content, the content is first prepared for streaming FIG. 5 is a flowchart that depicts example content preparation method 500 of a content system 102 in accordance with an embodiment. At block 502, a request to prepare the content item for streaming is received. As discussed below, this content preparation request may be automatically made on a content item being selected to be accessible to remote users (i.e. in advance of any actual user request for the content item), or may be made only once a content request for the content item is received. Embodiments of the invention may be used with a wide variety of original content types. By way of non-limiting example, original content types may include video files (e.g. QuickTime (.mov), MPEG-4 (.mp4) and 3GPP (.3gp)), image files (e.g., (.jpg), JPEG 2000 (.jp2), GIF (.gif), Windows Bitmap (.bmp), Portable Network Graphics (.png), Canon RAW (.cr2), Nikon RAW (.nef), and TIFF (.tiff)), audio files (MPEG-4 (.m4a)), plain text (e.g., txt)), pdf documents, word processor documents (e.g. Microsoft Word documents), presentation documents (e.g. Microsoft PowerPoint documents), and spreadsheet documents (e.g. Microsoft Excel documents). Additionally, some embodiments of this invention may be used with content items located on a private network that are accessed through industry standard communication protocols (e.g., Hypertext Transfer Protocol (HTTP), File Transfer Protocol (FTP), and Transmission Control Protocol (TCP)).

In order to be streamed, original content items are discretized into one or more discrete parts, which will be referred to as content primitives. For example, a ten page original textual content item (such as a Microsoft Word document) may be discretized into ten individual pages (primitives), each of which can be independently streamed to a user device 104.

In this embodiment, previews of content primitives, which are referred to as derivative content, may be viewed by a user prior to selecting to stream an entire content item or single content primitive. For example, a user may select to view only a thumbnail image of a single page of a document before selecting to view and actual page of the document or the document in its entirety.

At block 504, the domain storage engine 124 accesses the cache of the server where the content is located to determine if the requested content is located in the cache. If the content or derivative content is located in the cache, domain storage engine 124 will return the content or derivative content to the user device 104 at block 504. For example, if a user has requested a particular page of a particular document, the content server 102 will access to the page cache, and if the particular page is found it will return it to the user.

If the domain storage engine 124 determines that neither the requested content nor the derivative content is located in the server's cache, the domain storage engine 124 will then access the cache to determine if the primitives of the requested content are located in the cache. For example, if the user of the user device 104 has requested a document, the content management system 102 will check the cache for pages of the document. If no content primitives are found, the content management system 102 will again access the cache and attempt to locate the content requested.

If the requested content is not in the cache of the content sever, the domain storage engine 124 will access the content in the content server at block 506. Once the content has been retrieved, the content management system 102 will also create and store a local copy of the content in the server cache at block 506.

At block 508, the content type (e.g., file format) of the original content item is determined. In one embodiment, this determination is made based on magic number (e.g., a constant numerical value used to identify a file format) detection. In another embodiment, this determination is made with reference to the file name extension of the content item (e.g., .pdf for Portable Document Format (pdf) content items, .doc for Microsoft Word document content items, .ppt for Microsoft PowerPoint presentation content items, .xls for Microsoft Excel spreadsheet content items).

Once the content type of the content has been determined, the primitive type (i.e., the “parts” into which the content item will be split) for that content type is identified at block 506. For example, the primitive type for a textual content item (e.g. a word processor or .pdf document) may be sections (e.g., chapters), pages, or paragraphs. The primitive type for a presentation document may be slides. The primitive type for a spreadsheet document may be individual sheets. In one embodiment, the preparation of each different primitive type of content is handled by an asset operator module 138. For example, content system 102 may include respective asset operator modules 138 for .doc content items, .pdf content items, .xls content items, .ppt content items, etc.

In some embodiments, the primitive type for a given content item is automatically determined at block 510 based on the content type of the content item. In other embodiments, the primitive type for a content item may be determined with reference to additional content item metadata and/or user input. For example, possible primitive types for a textual document may be sections, pages, or paragraphs. The default primitive type for a textual content item may be pages. If desired, however, a user may instead select to set the primitive type to paragraphs or sections. As a further example, if content item metadata indicates that a content item is structured in a particular way, the primitive type may be selected based on the structure of the content item. For example, if the content item is indicated by metadata to be a novel, chapters may be selected as the primitive type even if the default for the content type “document” is pages.

At block 512, the original content item is divided or discretized into its one or more primitives according to the primitive type determined at block 510. The creation of primitives depends on the type of content item in question and the primitive type. For example, a textual content item with the primitive type set to be pages may be processed by extracting data from the content item page by page, and writing a new content primitive file for each page.

At block 514, each of the content item primitives is formatted to a format for streaming and saved (in this instance) to the content database 132 and a copy will be stored in cache 162. In one embodiment, content item primitives are formatted into a common file format regardless of their original type. The common file format may, for example, be a widely available format such as .pdf or .jpg. Alternatively, the file format may be a proprietary file format. By providing all content primitives in a file format user devices 104 need only have software for viewing files of the elected format. Further, if a proprietary file format is selected, the security of the content is increased as software or hardware capable of reading the proprietary format will be necessary to view it. As discussed below, content item primitives may be encrypted prior to streaming.

At the completion of block 514, the formatted primitives are ready for streaming to a user. In some embodiments, however, further preparation is undertaken to enhance the content streaming process. For example, at block 516, a preview (i.e., a content derivative), of each content item primitive may be generated. The preview may have a smaller file size that the content item primitive and can be rapidly streamed to a user to provide a quick preview of the primitive. The preview may, for example, be a jpeg or bitmap thumbnail of the content item primitive. In some embodiments, multiple previews of different sizes may be generated for content parts to further enhance content streaming.

As with the preparation of content items itself, content primitive previews may be automatically prepared when the content item is prepared, or may be prepared on demand when a user request to access the content item is received. If content primitive previews are prepared, the previews may be stored in the content database 132.

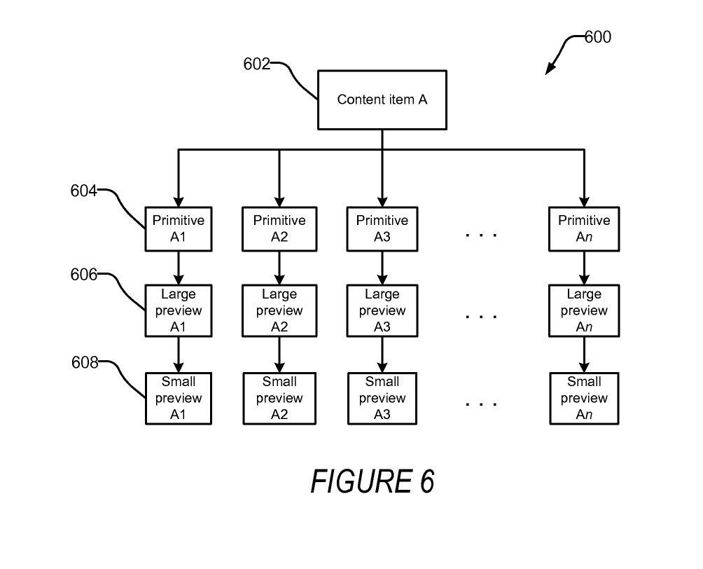

Referring to FIG. 6, a diagram 600 showing a map of a discretized content item is shown. As can be seen, the primitive type determined for content item A 602 resulted in content item A being discretized into n content item primitives 604 (e.g., primitive A1, primitive A2, primitive A3, . . . primitive An). Each of those content primitives 604 was, in turn, processed to provide a large preview 606 (e.g., large preview A1, large preview A2, large preview A3, . . . large preview An) and a small preview 608 (e.g., small preview A1, small preview A2, small preview A3, . . . small preview An). Once prepared, the content item parts are stored (e.g., in database 132) ready for streaming to a user device.

In some embodiments, content items are prepared for streaming when each is designated as being available to be streamed. Preparing the content items at this time may be appropriate if the content item is located on a storage device that is only temporarily available (e.g., a temporary networked location or a portable storage device that will be disconnected). In other embodiments, content items may be prepared for streaming when a request from a user for the content item to be streamed is received thereby providing on-demand preparation of content items. In these instances, a copy of the original content item may be stored on a permanently available storage device (e.g., a locally accessible storage database).

Additional content preparation policies are, of course, possible. For example, a policy may be implemented that indicates that only a first pre-determined number (e.g., five) of primitives of a content item be initially prepared. When a user requests that content item, the first (e.g., five) primitives are streamed to the user immediately, and preparation of the next five or more primitives are then prepared and streamed to the user. If the user continues viewing the content item selects, for example, primitive six, the next five primitives (e.g., primitives eleven to fifteen) are prepared and streamed, and so on. In this way, if after viewing the first few primitives of a content item, the user is no longer interested in the content item, resources are not used to prepare the entire content item for streaming.

In addition, content caching policies may be implemented with respect to the storage of content item files (primitives and primitive previews) on database 132. For example, content item primitives or previews prepared for streaming may be maintained or deleted based on age (e.g., how long the content item files have been stored in the database), last access time (e.g., a time stamp of the last time a request for the content item was received), popularity (e.g., how many requests for the content item have been received), or other caching conditions.

In the above embodiment, the preparation of content items for streaming has been described as being undertaken at the content system 102. In alternative embodiments content preparation may be performed by alternative systems. For example, in one alternative embodiment, content items may be transmitted to the session management system 106, and content item primitives (and primitive previews) prepared by the session management system 106 and forwarded back to the content system 102. A model such as this may avoid the need for content preparation applications to be installed or executed by the content system 102, and may provide additional or alternative revenue streams by imposing a charge for preparing content for streaming.

As will be appreciated, the various embodiments described above allow a private entity in control of a secured content server 102 to serve content to a remote user device 104 over a public network 108 in a relatively simple and secure manner. Although a third party system (e.g., session management system 106) is used to authenticate users and establish a session between the content server 102 and user device 104, no actual content may be stored on that third party system or elsewhere outside of the content system 102. Further, by adopting the streaming model for content delivery, content can be presented to remote devices without permitting the content to be saved to the user device 104—e.g., such that once the session in which the content is streamed has been terminated the content is no longer accessible at the user device.

Receiving and Interacting with Content

As outlined above, embodiments allow a user of a user device (such as device 104) to access content from a content system (e.g. system 102) remotely.

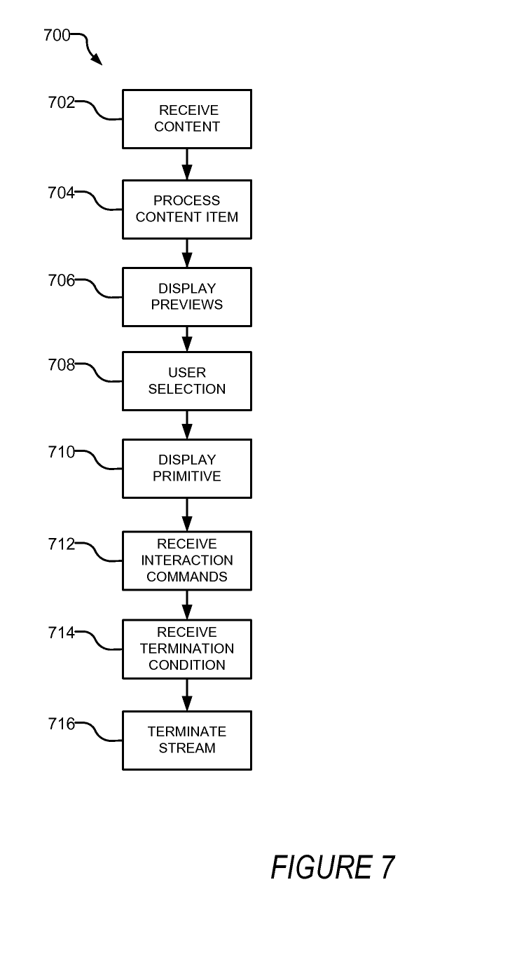

FIG. 7 is a flowchart that depicts example user device operations 700 in accordance with an embodiment. Operations 700 are performed at a user device (such as user device 104) in order to access and interact with content from a content system (such as content system 102). At the start of operations 700, the user device 104 has already established a session according to operation 200 and has accessed a particular content item according to operation 300.

At block 702, the user device 104 has received content from the domain policy engine 122. As content item primitives are received at the user device as part of a content stream, the primitives are cached at the user device by the cache module (not shown) of the user device and processed in preparation for presentation at block 704. For example, if the content primitives and/or primitive previews are encrypted, they are decrypted by the encryption module (not shown) of the user device as part of the processing at block 704.

If content primitive previews have been received, these are presented to the user as the primitive previews are received at step 706. If a preview is selected or otherwise activated by a user at block 708, the primitive is displayed at block 710. If the content stream does not include primitive previews, primitives are displayed at block 710.

By discretizing content items into primitives, a user of a user device 104 can commence viewing the content item as soon as the first primitive has been received at the user device 104—i.e., without waiting for all primitives making up the content item to be delivered.

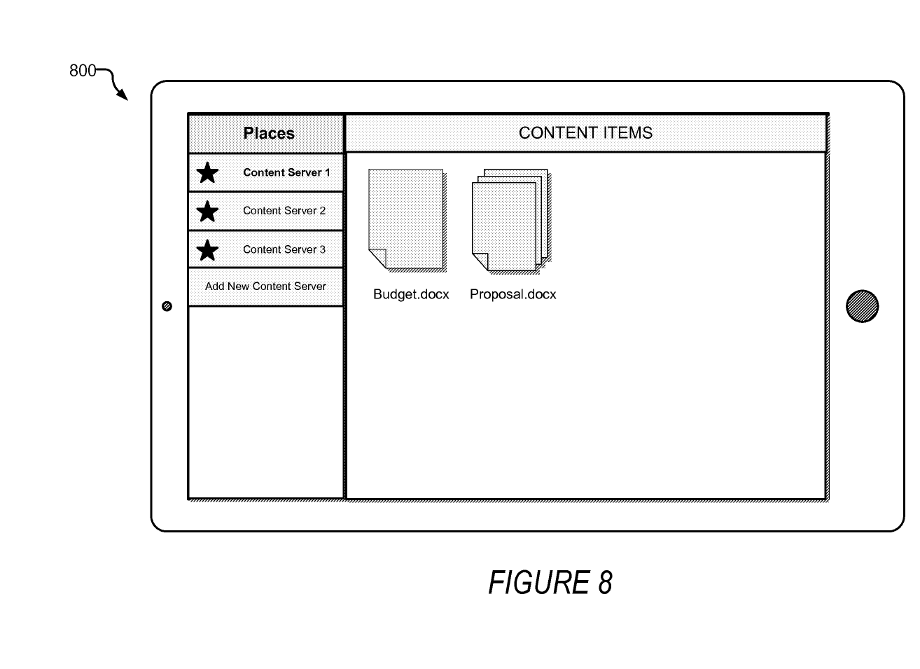

At block 712, the user may interact with the content item primitives received. Interaction functions are provided by the user interface module (see FIG. 8) and may include viewing or listening to the content item primitives, commencing a slide show of the content item primitives (such that the user device automatically displays the content item primitives in a sequential manner), and manually navigating between content item primitives.

At block 714, a termination condition is satisfied at the user device 104. In some embodiments, the termination condition may be specified by the content management system administrator. Satisfaction of a termination condition may, by way of non-limiting example, include an expiration of a time limitation associated with the content, the user moving in or out of a specific geographic area, or the user changing the mode of communication used in accessing the content. For example, the termination condition would be satisfied when the user has completed an interaction with the primitives corresponding to the content item and has selected to end streaming. In an alternative example, the user may have had a time limit associated with a content item that has run its course resulting in a termination condition being satisfied at the user device 104.

At block 716, the satisfaction of the termination condition results in a termination message being transmitted to the cloud policy engine. The session management system 106 then sends the termination message to the content management system 102. The receipt of the termination message results in the content stream being terminated and prevents the user from further viewing or accessing the primitives corresponding to the content item.

FIG. 8 is a depiction of a portion of a user interface 800 provided by a user device to a user in accordance with an embodiment. The user interface 800 includes a menu on the left side of the user interface that allows a user to select a content server 102 from a plurality of content servers known to the user. The user interface 800 further includes a second portion on the right side of the user interface for selecting and/or viewing particular content items. As depicted, the second portion displays a thumbnail image (e.g., a preview primitive) and file name each content item available for streaming. Upon selection of a content item, the selected content item is streamed to the user device 104 by the content server 102 and displayed in the second portion or a new interface may be generated to display the content item.

### Delegated Access Permission

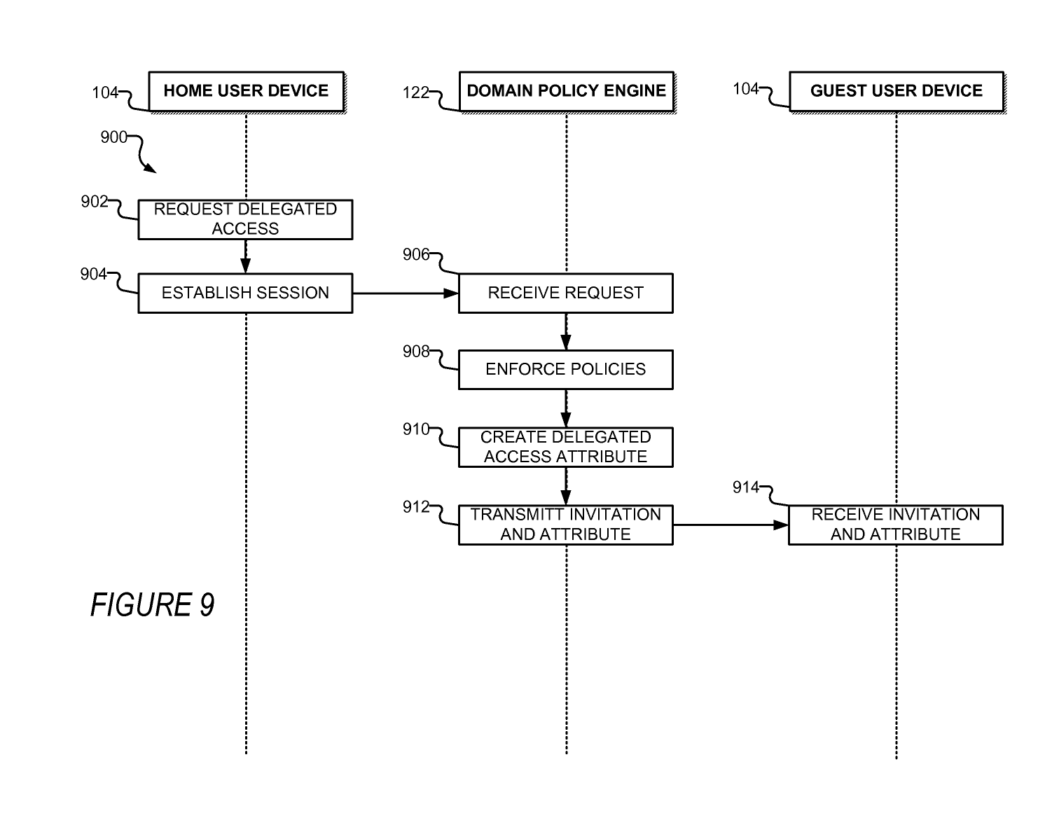

Embodiments provide the ability for access to content items to be delegated by users of a user device 104. As mentioned above, a permission that can be set in relation to content items relates to whether a user (or user group) is permitted to give other users permission to access a content item to which the user himself has access. FIG. 9 is a flow chart illustrating delegated access operations 900 in accordance with this embodiment.

At block 902, a user, referred to as the home user, inputs a request to the user device 104 to allow the ability to grant access to a stream of primitives corresponding to particular content item to a particular guest user. The guest user may be identified to the system by any number of unique identifiers. For example, the guest may be identified by a username specific to that guest user or by the guest user's email address.

In some embodiments, the request to grant access to a guest user may include limitations set by the home user. For example, the request to grant access to a guest user may include a limit to the amount of time the guest user may access the content or may include a limit to the time of the day during which the guest user will be able to access the content.

At block 904, the home user establishes a session with the cloud policy engine 116 in the same manner as described by operation 200. The request submitted to the user device 104 by the home user is, in turn, transmitted to the cloud policy engine 116 at block 906.

At block 908, the cloud policy engine 116 enforces the domain policies. These policies may include whether the home user has the ability to delegate access to content items.

At block 910, the cloud policy engine 116 creates an attribute that links the guest user's unique identifier, the content for which access is sought, and permission information to an identifier of the home user. The permissions will include the permissions established by the home user at block 902.

At block 912, the cloud policy engine 116 transmits an invitation to access content to the guest user along with the attribute created at block 910. The invitation includes several provisioning details. For example, the invitation may include the electronic location of the content to be accessed, the name of the content item, geographic restrictions associated with the content item, and time restrictions associated with the content item.

At block 914, the guest user receives and accepts the invitation sent by the cloud policy engine 116. Once a guest user accepts the invitation to access a content item, a link is displayed on the user device of the guest user. This link includes, for example, the name of the content item and the electronic location identifying where the content item may be accessed by the guest user. In one embodiment, all content items for which access is granted to a guest user by a particular organization will be grouped together for ease of access.

### Guest User Authentication

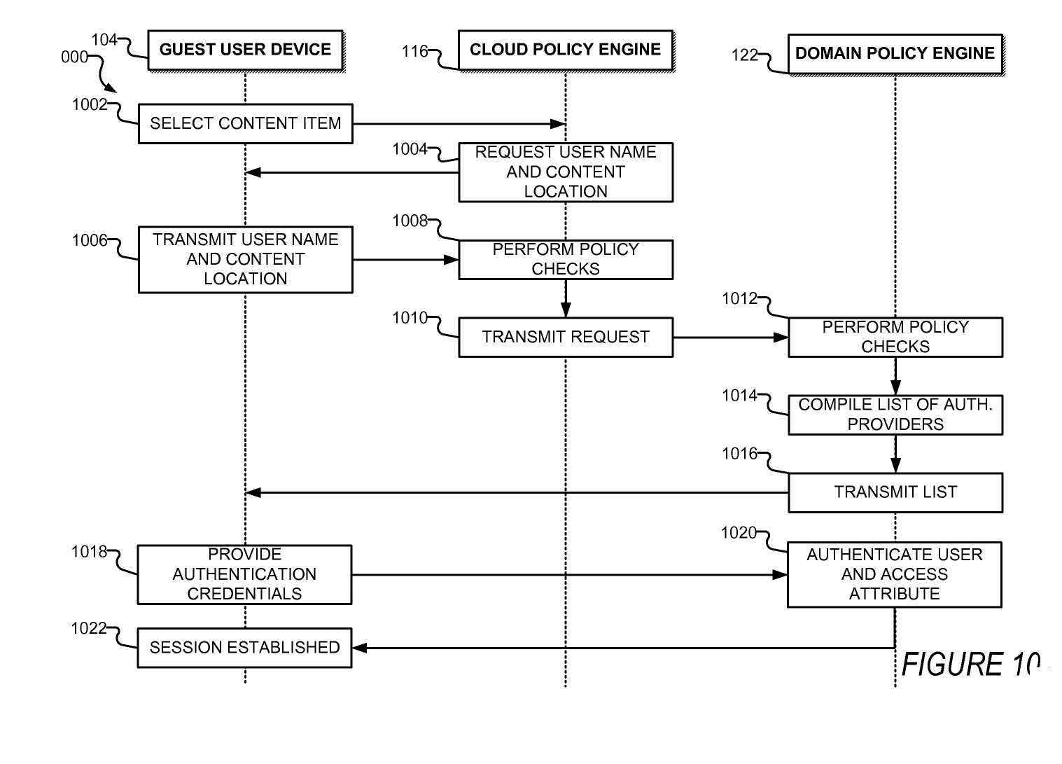

A guest user that is granted access by a home user must still establish a content session with the cloud policy engine 116 and domain policy engine 122 in order to access the content. FIG. 10 is flow chart that depicts an example method 1000 comprising operations to establish a session connection between a guest user and the content system 102 in accordance with an embodiment.

At block 1002, the user selects a content item to view that he has been granted access to in accordance with operations 900. At block 1004, the cloud policy engine 116 receives the selection and requests the guest user's user name and the location of the content which is returned to the cloud policy engine 116 at block 1006.

At block 1008, the cloud policy engine 116 performs local policy checks. The cloud policy engine 116 then transmits the request to the domain policy engine 124 at block 1010. At block 1012, the domain policy engine 122 performs local policy checks and accesses the attribute created in operations 900. At block 1014, the domain policy engine 124 compiles a list of required credentials at block 1014. These credentials include a list of authentication providers (e.g., Linkedin, openAuth, Facebook) coupled with the credentials required by each (e.g., a password). This list is then transmitted to the guest user at block 1016.

At block 1018, the guest user is presented with a log-in screen that allows the guest user to select the authentication provider he desires to use to authenticate himself. Once a guest user has selected an authentication provider, he will be prompted to provide all associated credentials associated with that authentication provider. This information is communicated by the guest user to the cloud policy engine 116 through the cloud policy engine 116 with each system performing a policy check along the way.

At block 1020, the domain policy engine 122 contacts the authentication provider (not shown) selected by the user at block 1018. The domain policy engine 122 provides the username and credentials to the authentication provider to authenticate the guest user before providing the content item. If the user name and credentials are correct, the domain policy engine 122 authenticates and records the guest account. In one embodiment, the guest account information is saved so that during subsequent content sharing with a same guest user additional authentication will not be required.

At block 1022, a session is established with the user device of the guest user. After a session is established, the guest user may access content in a manner as described above in connection with FIG. 3.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 11 is a block diagram of machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation device 1114 (e.g., a mouse), a disk drive unit 1116, a signal generation device 1118 (e.g., a speaker) and a network interface device 1120.

### Machine-Readable Medium

The disk drive unit 1116 includes a machine-readable medium 1122 on which is stored one or more sets of instructions and data structures (e.g., software) 1124 embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media.

While the machine-readable medium 1122 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method for delivering content, the method comprising:
establishing a content sharing session between a user device and a content system;
accessing, using one or more processors, content primitives generated from a content item controlled by the content system; and
transmitting the content primitives to the user device.

2. The method of claim 1, further comprising:
accessing, using one or more processors, derivative content generated from the content item controlled by the content system; and
transmitting the derivative content to the user device.

3. The method of claim 2, wherein the derivative content is a thumbnail image preview of a content primitive of the content primitives of the content item.

4. The method of claim 1, further comprising:
enforcing local policies of the content system.

5. The method of claim 1, further comprising:
receiving a termination condition from the user device;
terminating the content session between the user device and content management system if the termination condition is satisfied.

6. The method of claim 5, wherein the termination condition is a time limitation for access to the content primitives.

7. The method of claim 1, wherein the content primitives are generated by:
determining a content type of the content item;
determining a content primitive type based on the content type of the content item;
dividing the content item into one or more discretized parts based on the content primitive type;
formatting the one or more discretized parts into a common file format to generate the content primitives; and
storing the content primitives.

8. The method of claim 7, wherein the common file format is selected from the group consisting of a Portable Document Format (pdf), a JPEG, and a proprietary file format.

9. The method of claim 1, wherein the establishing of the content session between the user device and the content system comprises:
receiving an encrypted authenticated request for access to the content item from the session management system, the authenticated request for access to the content item originating from the user device and authenticated by the session management system; and
initiating a cryptographic key-exchange between the content system and the user device to establish the content session with the user device.

10. The method of claim 9, wherein the establishing of the content session between the user device and the content system further comprises:
performing additional authentication of the authenticated request for access to the content item received by the session management system.

11. The method of claim 1, wherein establishing the content session between the user device and the content system comprises:
receiving a request for access to the content item from the user device;
accessing credentials stored at the session management system;
authenticating the user device based on credentials controlled by the session management system; and
transmitting a key to the user device to establish the content session with the user device.

12. The method of claim 1, wherein the content item is selected from the group consisting of a video file, an image file, an audio file, plain text, a word processing document, a spreadsheet, a set of presentation slides, and a file formatted according to a Portable Document Format (pdf).

13. The method of claim 1, wherein the user device is a mobile device.

14. The method of claim 1, wherein the establishing of the content session between the user device and the content system further includes establishing a content sharing session with a partner content system.

15. The method of claim 1, further comprising:
initiating delegated access to a guest user device based on the established content sharing session.

16. The method of claim 15, further comprising:
identifying the user device with the established content sharing session as a user device permitted to delegate access to the content item.

17. The method of claim 16, further comprising:
authenticating the user of the guest user device using a public authentication provider.

18. The method of claim 17, further comprising:
establishing a content session between the guest user device and the content system;

19. The method of claim 18, further comprising:
transmitting the content item to the guest user device.

20. The method of claim 16, wherein the public authentication provider is a social networking website.

21. The method of claim 1, wherein the content item is retrieved from a private network using a standard communication protocol.

22. A session management system comprising:
a first policy engine to authenticate a user of user device upon receiving a request for a content item stored on a content system, the content system comprising a second policy engine to enforce policies of the content system;
a storage engine to access a location of one or more content primitives corresponding to the content item and to cause the content primitive to be transmitted to the user device.

23. The session management system of claim 22, wherein the first policy engine is further to allow the one or more content primitives to be transmitted to a second user device based on an indication that delegated access to the one or more content primitives has been granted and an authentication of a second user of the second user device.

24. The system of claim 23, wherein the storage engine is further to determine that the content item is controlled by a partner content system, the partner content system being federated with the content system and having a third policy engine to authenticate the user and enforce policies of the partner content system, and to cause the content primitives to be transmitted to the user device.

25. A non-transitory machine readable medium having instructions embodied thereon, the instructions that, when executed by the machine, cause the machine to perform operations comprising:
establishing a content sharing session between a user device and a content system;
accessing, using one or more processors, content primitives generated from a content item controlled by the content system; and
transmitting the content primitives to the user device.
